(19) United States
(12) Patent Application Publication
(10) Pub. No.: US 2006/0071378 A1
(43) Pub. Date: Apr. 6, 2006

(54) Fluid suspension apparatus and method of manufacturing same

(75) Inventor: Kevin K. Brown, Carmel, IN (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: BFS Diversified Products, LLC

(21) Appl. No.: 10/959,441

(22) Filed: Oct. 5, 2004

(51) Int. Cl. F16F 5/00

(52) U.S. Cl. 267/122; 267/64.11

(57) ABSTRACT

A fluid suspension device includes a first end member, a second end member and a flexible member supported therebetween. A method of manufacturing a fluid suspension member is included.

### BACKGROUND

The present novel apparatus broadly relates to the art of fluid suspension systems and, more particularly, to a fluid suspension apparatus adapted for quick connection along an associated damping member and having a frustoconical wall portion on at least one end member that is formed from sheet material.

The present apparatus finds particular application in association with air suspension systems of vehicles, such as passenger cars, pickup trucks and SUVs, for example, and will be described below with particular reference thereto. However, it is to be appreciated that the present apparatus is equally applicable for use in association with other devices, systems and/or environments. For example, the present apparatus can be used in support structures, height adjusting systems and actuators associated with industrial machinery, components thereof and/or other such equipment. Accordingly, the subject apparatus is not intended to be limited to use associated with vehicle suspensions.

Vehicles, such as passenger cars, pickup trucks and SUVs commonly include a damping member and a spring on each corner of the vehicle. The damping member and spring are secured between a wheel supporting structure and the chassis or body of the vehicle. In many cases, the damping member is a strut, and the spring is a coil spring that is disposed around the exterior of the strut. This type of arrangement is now commonly used as the same reduces the envelope or space required for mounting and operation when compared to more traditional (coil or leaf) spring and shock absorber arrangements. When used with a strut, the coil spring is typically supported on and between a housing and damping rod of the strut rather than being secured to the vehicle itself. Oppositely, in a shock absorber and spring arrangement, both components are mounted to and between the two parts of the vehicle, namely, the chassis or body and the wheel supporting structure.

Frequently, an original damping member and coil spring arrangement will be replaced with a damping member and air spring arrangement. This can improve performance and handling of the vehicle, as well as provide height adjusting features not originally found on the vehicle. In some cases, the original suspension components will be replaced by independently selected damping members and air springs that are subsequently assembled together and installed on the vehicle. In other situations, a damping member and air spring assembly can be used to replace the original suspension components. These latter assemblies are designed for synergistic performance and, as such, have benefits over the use of independently selected components. Even so, certain disadvantages exist with these assemblies as well.

One such disadvantage is that the end members for the air spring portion of these assemblies are manufactured from billet aluminum or another suitable metal. This can undesirably increase the weight of the overall assembly. Additionally, these assemblies often include an upper end member that has a frustoconical outer surface. This is primarily done to provide a suitable mounting arrangement to fit within the envelope of the original suspension arrangement and connect it to the vehicle using the original mounting arrangement. However, these assemblies with the machined end members do not provide any significant increase in volume of the air spring.

Another disadvantage is that these assemblies typically capture the resilient bellows or sleeve between opposing end plates, which form the respective end members of the air spring. The end plates are secured together using fasteners to form a fluid-tight seal with the resilient member. Undesirably, leaks can be formed adjacent areas where one or more fasteners become loosened. However, assembly of the air spring using fasteners is maintained due to the construction and material of the machined end members, among other things. As such, these air spring assemblies tend to be expensive to manufacture and assemble, and also include undesirable physical characteristics, such as increased size and weight as well as reduced volume of the air spring, as discussed above.

### BRIEF DESCRIPTION

An air spring according to one embodiment of the present novel concept for use with an associated damping member having an associated housing and an associated damping rod displaceably supported along the associated housing is provided that includes an upper end member, a lower end member and a flexible spring member. The upper end member is supported on the associated damping rod and includes an upper end wall substantially formed from sheet material. The upper end wall includes a frustoconical wall portion. The lower end member is supported on the associated housing and includes a lower end wall substantially formed from sheet material. The lower end wall includes a central wall portion received along the associated housing and removably secured thereto. The flexible spring member is supported between the upper and lower end members.

A suspension assembly according to another embodiment of the present novel concept and adapted for use on an associated vehicle having associated upper and lower vehicle portions is provided that includes a damping member and a fluid suspension device. The damping member is supported between the associated upper and lower vehicle portions and includes a housing and a damping rod movably supported within the housing. The fluid suspension device is supported on the damping member and includes a first end member supported on the damping rod, a second end member supported on the housing in spaced relation to the first end member, and a flexible suspension member supported between the first and second end members. The first end member includes a first wall substantially formed from sheet material. The first wall includes a frustoconical wall portion. The second end member includes a second wall substantially formed from sheet material and also includes an intermediate wall portion.

A method of manufacturing a fluid suspension member according to one embodiment of the present novel concept is provided that includes a step of providing sheet material and a flexible member that includes a side wall extending between opposing open ends. Another step includes forming a first end member from the sheet material. The first end member includes a first end wall having at least a frustoconical wall portion and a first peripheral wall portion formed outwardly from the frustoconical wall portion. Another step includes forming a second end member from the sheet of material. The second end member includes a second end wall having at least a mounting sleeve and a second peripheral wall portion formed outwardly from the mounting sleeve. Another step includes securing the side wall of the flexible member on the first and second peripheral wall portions to form the fluid suspension member.

### BRIEF DESCRIPTION OF THE DRAWINGS

FIG. 1 is a side view of one embodiment of a fluid suspension member according to the present novel concept shown supported on a damping member.

FIG. 2 is a top view of the fluid suspension and damping members in FIG. 1.

FIG. 3 is a side view, in partial cross section, of the fluid suspension and damping members shown in FIGS. 1-2 taken along line 3-3 of FIG. 2.

FIG. 4 is a top view, in partial cross section, of the fluid suspension member shown in FIGS. 1-3 taken along line 4-4 in FIG. 3.

FIG. 5 is an enlarged view of DETAIL 5 shown in FIG. 3.

FIG. 6 is an enlarged view of DETAIL 6 shown in FIG. 3.

### DETAILED DESCRIPTION

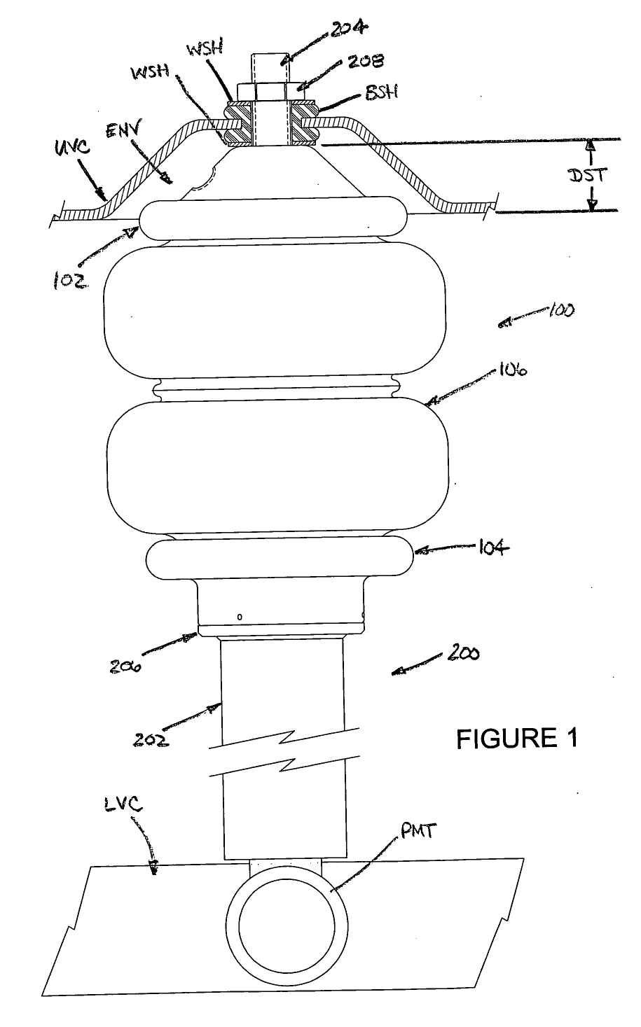

With reference to FIG. 1, a fluid suspension member or device 100 includes a first end member 102, a second end member 104 in spaced relation to the first end member, and a typical, flexible fluid suspension member 106 supported therebetween. Fluid suspension device 100 is supported on a damping member 200 that includes a housing 202 and a damping rod 204 displaceably supported on housing 202. Device 100 is supported on the damping member between a collar 206 secured along housing 202 and a retaining nut 208 that threadably engages damping rod 204 opposite collar 206.

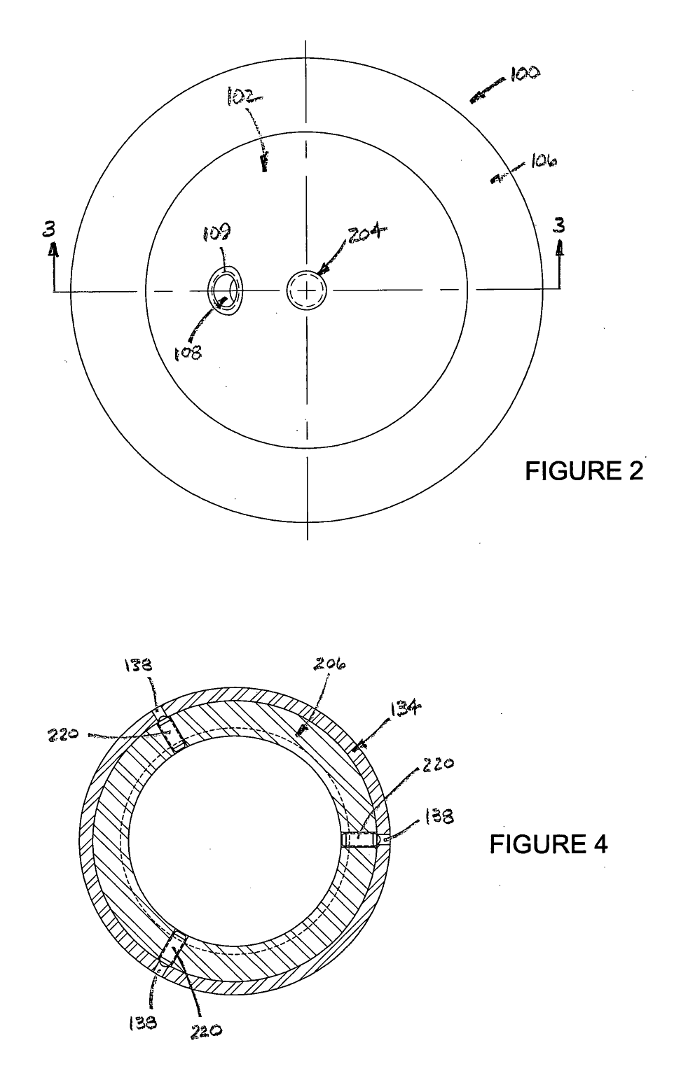

As can be better seen in FIG. 2, first end member 102 has a passage 108 extending therethrough. The passage is preferably suitably adapted to receive a traditional fluid line fitting (not shown) to supply and exhaust fluid to and from device 100. For example, passage 108 is shown as having a plurality of threads 109 formed therealong. It will be appreciated, however, that any suitable connection arrangement can be used.

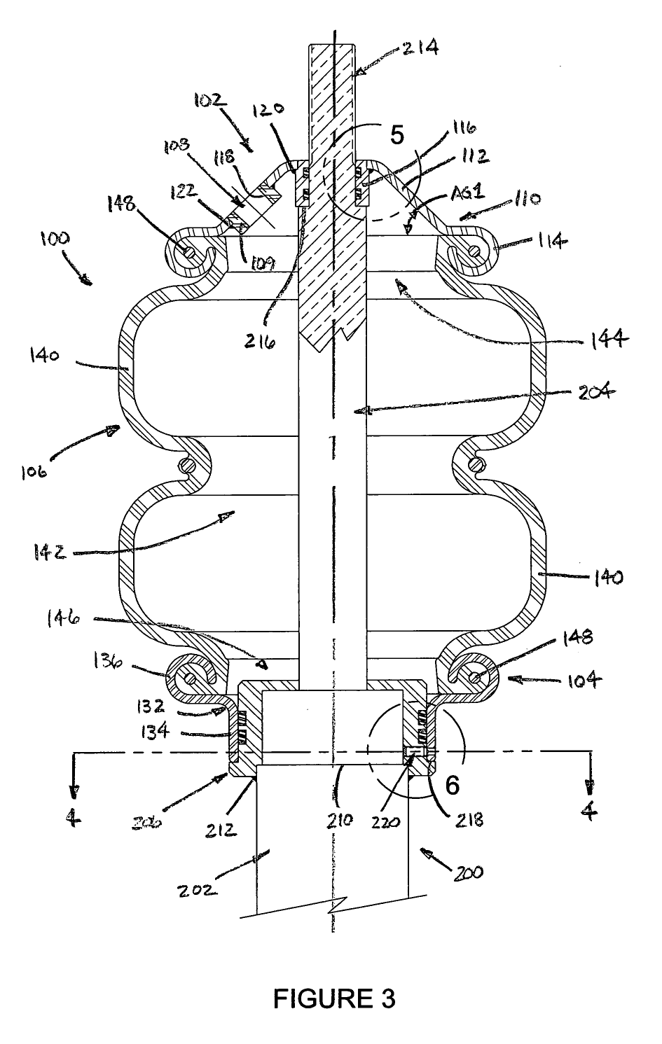

With reference to FIG. 3, it will be appreciated that housing 202 and damping rod 204 of damping member 200 are of substantially traditional construction and operation with respect to one another. Additionally, it should be appreciated that any suitable type of damping member can be used, including devices known as shocks or shock absorbers, as well as struts. Furthermore, the damping member can optionally be constructed to provide variable or otherwise adjustable damping rates. One difference from traditional construction, however, is that collar 206 is provided on housing 202 and can be secured thereon in any suitable manner. For example, collar 206 can be received on a shoulder 210 of housing 202 and attached thereto using a flowed-material joint 212 as shown in FIG. 3. It will be appreciated that any suitable flowed-material joint, such as a weld or a braze, for example, or any other suitable connection method can be used. Preferably, however, a fluid-tight seal or connection is formed between housing 202 and collar 206. Therefore, if a fastener arrangement (not shown) is used to secure the collar on the housing, then preferably one or more sealing members (not shown) will be used to form the fluid-tight connection.

Damping rod 204 extends from housing 202 and includes a threaded end 214 opposite housing 202 that receives retaining nut 208. A shoulder 216 is formed on the damping rod and first end member 102 is captured between the shoulder and the retaining nut.

First end member 102 includes a first wall 110 having a frustoconical wall portion 112 and an outer peripheral wall portion 114. First end member 102 also includes a mounting ring 116 and a connecting ring 118. The mounting and connecting rings are supported on first wall 110 in a suitable manner, such as by using a flowed-material joint, for example, though it will be appreciated that any suitable connection arrangement can be used. Rings 116 and 118 are shown in FIG. 3 as being attached to first wall 110 by joints 100 and 122, respectively.

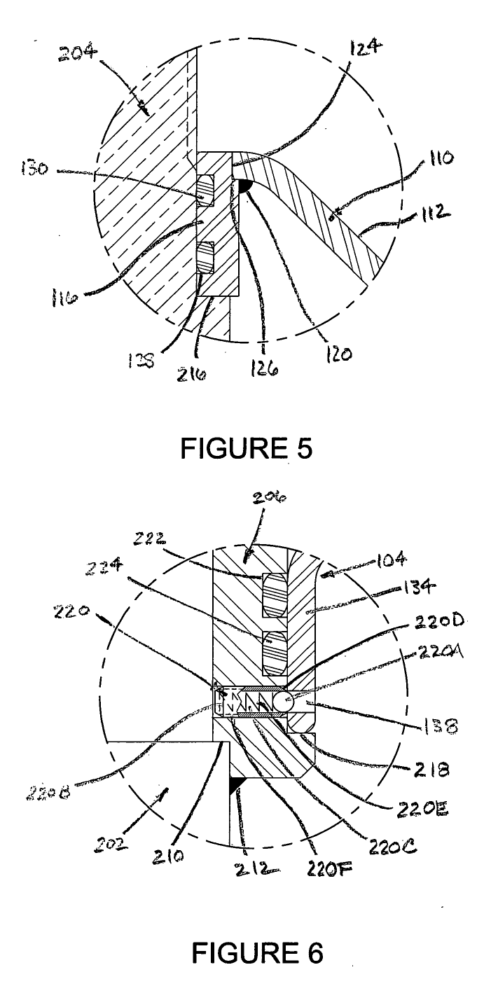

As can be better seen in FIG. 5, first wall 110 includes an opening (not numbered) at least partially formed by an inner side wall 124. Preferably, the opening is dimensioned such that at least a portion of first wall 110 is received on a shoulder 126 of mounting ring 116. Additionally, mounting ring 116 includes radially outwardly extending grooves 128 that receive suitable sealing members, such as o-rings 130, for example, to form a fluid-tight seal between ring 116 and damping rod 204.

Second end member 104 includes a second wall 132 having a substantially cylindrical wall portion 134 and an outer peripheral wall portion 136. Wall portion 134 forms a sleeve that is received along collar 206 and supported on a shoulder 218 formed thereon. Second end member 104 can be secured on collar 206 in any suitable manner. In one preferred embodiment shown in FIGS. 3, 4 and 6, the end member is removably supported on collar 206 by a plurality of spring-biased, retractable retaining members 220 having a displaceable retainer portion 220A that engages receivers, such as retaining openings 138 formed through cylindrical wall portion 134, for example. Retaining members 220 are of typical construction and have a housing 220B with an internal cavity (not shown) and an open end (not shown) through which retainer portion 220A projects. The retainer portion is biased toward the open end by a spring (not shown). In the embodiment shown, housing 220B includes a plurality of threads 220C. However, it will be appreciated that any suitable manner of mounting the retaining members can be used. Additionally, three retaining members are shown in FIG. 4 disposed at about 120 degree angles from one another. However, it will be appreciated that any number of one or more retaining members can be used and oriented in any desired manner. Additionally, the one or more retaining members can alternately be mounted on wall portion 134 and engage a receiver on collar 206.

Collar 206 includes radially inwardly extending grooves 222 that receive suitable sealing members, such as o-rings 224, for example. The sealing members form a substantially fluid-tight seal between collar 206 and cylindrical wall portion 134 of second end member 104.

Flexible suspension member 106 is supported between first and second end members 102 and 104. Flexible suspension member 106 is shown in FIGS. 1 and 3 as having a plurality of bellows. However, it will be appreciated that any suitable type or style of flexible suspension member can be used, including flexible-wall, sleeve-type suspension members. Flexible suspension member 106 includes a side wall 140 that at least partially forms a fluid chamber 142 extending between opposing open ends 144 and 146 respectively adjacent first wall 110 and second wall 132. An annular mounting bead 148 is formed along side wall 140 adjacent each of open ends 144 and 146. It will be appreciated that flexible suspension members are generally well known and commonly used and that a variety of other mounting features and/or geometries can be used.

It will be appreciated from the drawings that first wall 110 of first end member 102 and second wall 132 of second end member 104 are substantially formed from sheet material. In one preferred embodiment, the sheet material is metal, which can be formed in any typical manner well known by those of skill in the art, including stamping, punching, sheering, breaking, coining and/or any other suitable method of metal forming. Though any suitable thickness can be used, the metal sheet material from about 3/32 of an inch to about 3/16 of an inch in thickness is typically used. Alternatively, the thickness of the metal sheet material can be referred to by gauge size as will be well understood by the skilled artisan. Again, any suitable gauge sheet metal can be used, though material of 9, 10 or 11 gauge, for example, is commonly used. Additionally, the sheet metal can be formed from any suitable material, such as carbon, stainless or alloy steel, for example. Furthermore, the sheet material can include further processing for strength and/or appearance improvements, such as heat treating or plating, for example.

As shown in FIG. 3, frustoconical portion 112 projects outwardly from flexible suspension member 106 substantially increasing the volume of chamber 142 without changing the length or diameter of the fluid suspension device when compared to similarly-shaped devices machined from billet material. This can advantageously increase the volume of the air spring by from about 5 percent to about 10 percent, while also reducing the overall weight of the assembly. Frustoconical portion 112 can extend at any suitable angle AG1 as may optionally benefit the specific environment, application and/or envelope within which the fluid suspension member may be used. In one example of a suitable arrangement, angle AG1 can be from about 15 degrees to about 75 degrees, and preferably from about 30 degrees to about 60 degrees.

One benefit of increasing the volume of the air spring in this manner is that the increased volume is provided without a corresponding increase in the exterior size or envelope of the air spring, especially when compared to other air springs having end members machined from billet material. It is advantageous to increase the volume of an air spring for a number of reasons known by those of skill in the art. One such reason is that increasing the volume of an air spring typically provides an effective reduction in the spring rate of the air spring. This helps to provide a softer, and typically more comfortable, ride in the associated vehicle without a corresponding change in any of the other characteristics of the air spring, such as load capacity or operating height, for example, which could negatively impact the vehicle and/or the performance thereof.

In assembling fluid suspension device 100, peripheral wall portions 114 and 136, respectively of first wall 110 and second wall 132, are deformed or crimped around the associated annular mounting bead. This forms a substantially fluid-tight seal between the end member and the flexible suspension member. As such, a fluid-tight suspension device is formed that permits the ingress and egress of fluid respectively to and from fluid chamber 142 only through the openings in first and second end members 102 and 104. Thereafter, once fluid suspension device 100 has been assembled onto damping member 200, the only operable fluid passage remaining is passage 108 formed in first end member 102. A suitable fluid line connection can then be made to supply and exhaust fluid from chamber 142.

Another benefit of providing an air spring having an increased volume (within the same outer envelope) is that the spring rate can be optimized for different vehicles, such as by slightly reducing the volume of the air spring, for example. One method of accomplishing this that is well known by those of skill in the art includes introducing a quantity of an incompressible fluid, such as water, antifreeze or another compatible liquid, for example, into the fluid chamber of the air spring. Any suitable quantity of liquid can be added, such as from about 5 to about 15 fluid ounces, for example. As an illustration, the spring rate of one group of air springs according to the present novel concept can be optimized for use on one vehicle by filling from about 3 to about 6 ounces of suitable fluid into the spring chambers thereof. The spring rate of another group of the same air springs according to the present novel concept can be optimized for use on a second, different vehicle by filling from about 8 to about 11 ounces of a suitable fluid into the spring chambers thereof. As such, by providing an air spring that has an overall increased volume, the same version of the air spring can be optimized for use on different vehicles due, at least in part, to this increased volume. Additionally, a similar practice can be employed for tailoring a fluid suspension member for use as a machine support where it is desired to isolate a certain vibration frequency, as is well understood by skilled artisans.

In addition to the foregoing, one benefit of fluid suspension members in accordance with the present novel concept is that well established mass production methods and equipment can be used to manufacture these devices at a relatively low cost. Whereas, other known constructions are not adapted to make use of such air spring manufacturing methods and equipment and, as such, do not take full advantage of the efficiencies and cost savings associated with the same. Another benefit of fluid suspension members in accordance with the present novel concept is that the same have improved size, weight and volume characteristics over other constructions. A further benefit is that such fluid suspension members are adapted to quickly and easily attach to an associated damping member. As such, they are well suited for convenient replacement and/or retrofit of OEM parts on vehicles.

While the present novel concept has been described with reference to the foregoing embodiments and considerable emphasis has been placed herein on the structures and structural interrelationships between the component parts of the embodiments disclosed, it will be appreciated that other embodiments of the present novel concept can be made and that many changes can be made in the embodiments illustrated and described without departing from the principles of the present novel concept. Obviously, modifications and alterations will occur to others upon reading and understanding the preceding detailed description. Accordingly, it is to be distinctly understood that the foregoing descriptive matter is to be interpreted merely as illustrative of the present novel concept and not as a limitation. As such, it is intended that the present novel concept be construed as including all such modifications and alterations insofar as they come within the scope of the appended claims and the equivalents thereof.

1. An air spring for use on an associated vehicle with an associated upper vehicle component having an associated mounting envelope and an associated damping member having an associated housing and an associated damping rod displaceably supported along the associated housing, said air spring comprising:
an upper end member supported on the associated damping rod and including an upper end wall substantially formed from sheet material, said upper end wall including a frustoconical wall portion and an outer peripheral wall portion extending from said frustoconical wall portion;
a lower end member supported on the associated housing in spaced relation to said upper end member and including a lower end wall substantially formed from sheet material, said lower end wall including a central wall portion received along the associated housing and removably secured thereto; and,
a flexible spring member supported between said upper and lower end members and forming a fluid chamber that extends therebetween;
said frustoconical wall portion receivable on the associated upper vehicle component such that at least a portion of said fluid chamber formed by said flexible spring member and said upper and lower end members is disposed within the associated mounting envelope.

2. An air spring according to claim 1, wherein said upper end wall includes an opening formed therethrough.

3. An air spring according to claim 2, wherein said opening is a first opening receiving the associated damping member and said upper end member includes a second opening.

4. An air spring according to claim 2, wherein said upper end member includes a first sleeve supported along said upper end wall, said first sleeve including an inner wall at least partially forming an inner passage in communication with said opening.

5. An air spring according to claim 4, wherein said inner wall includes one of a plurality of threads and an annular groove.

6. An air spring according to claim 4 further comprising a sealing member received along said inner passage of said first sleeve.

7. An air spring according to claim 1, wherein said central wall portion of said lower end wall includes a substantially cylindrical mounting sleeve.

8. An air spring according to claim 7, wherein said mounting sleeve is integrally formed on said lower end wall.

9. An air spring according to claim 7 further comprising a sealing member forming a fluid-tight seal between said mounting sleeve and the associated housing.

10. A suspension assembly adapted for use on an associated vehicle having associated upper and lower vehicle portions with the associated upper vehicle portion having an associated mounting envelope, said suspension assembly comprising:
a damping member supported between the associated upper and lower vehicle portions, said damping member including a housing and a damping rod moveably supported within said housing; and,
a fluid suspension device supported on said damping member, said fluid suspension device including a first end member supported on said damping rod, a second end member supported on said housing in spaced relation to said first end member, and a flexible suspension member supported between said first and second end members and defining a fluid chamber together with said first and second end members;
said first end member including a first wall substantially formed from a first sheet material, said first wall including a frustoconical wall portion and an outer peripheral wall portion extending from said frustoconical wall portion, an end portion of said fluid chamber extends along said frustoconical wall portion and said first end member is supported on the associated upper vehicle portion such that said end portion of said fluid chamber is at least partially received within the associated mounting envelope;
said second end member including a second wall substantially formed from a second sheet material and including a central wall portion.

11. A suspension assembly according to claim 10, wherein said second end member is removably secured on said housing.

12. A suspension assembly according to claim 11 further comprising at least one spring-biased retaining member secured on one of said second end member and said housing and at least one corresponding receiver in the other of said second end member and said housing engaging said retaining member.

13. A suspension assembly according to claim 12, wherein said at least one corresponding receiver is one of a passage and a detent.

14. A suspension assembly according to claim 12, wherein said at least one spring-biased retaining member includes a housing having an interior cavity with an open end, and a spring and a displaceable retainer portion received in said cavity such that said spring biases said displaceable retainer portion toward said open end.

15. A suspension assembly according to claim 10, wherein said central wall portion of said second wall includes a generally cylindrical mounting sleeve extending along at least a portion of said housing.

16. A suspension assembly according to claim 15, wherein said mounting sleeve is integrally formed on said second wall.

17. A method of manufacturing a fluid suspension member for use on an associated vehicle having an associated vehicle component with an associated mounting envelope, said method comprising steps of:
a) providing sheet material and a flexible member that includes a side wall extending between opposing open ends;
b) forming a first end member from said sheet material that includes a first end wall having at least a frustoconical wall portion dimensioned for receipt within the associated mounting envelope and a first peripheral wall portion formed outwardly from said frustoconical wall portion;
c) forming a second end member from said sheet material that includes a second end wall having at least a mounting sleeve and a second peripheral wall portion formed outwardly from said mounting sleeve; and,
d) securing said side wall of said flexible member on said first and second peripheral wall portions to form said fluid suspension member.

18. A method according to claim 17, wherein said flexible member includes mounting beads formed therein along said opposing open ends, and step d) includes deforming said first and second peripheral wall portions around said mounting beads along respective ones of said opposing open ends of said flexible member to form a substantially fluid-tight seal therebetween.

19. A method according to claim 17 further comprising steps of:
e) providing a damping member having a housing and a damping rod extending from said housing; and,
f) positioning said fluid suspension member on said damping member such that said mounting sleeve of said second end member is supported along said housing.

20. A method according to claim 19 further comprising steps of:
g) providing a spring-biased retaining member on one of said mounting sleeve and said housing and a corresponding receiver on the other of said mounting sleeve and said housing; and,
h) engaging said retaining member and said receiver to secure said second end member on said housing.

21. An air spring according to claim 1, wherein said flexible spring member includes first and second open ends respectively disposed toward said upper and lower end members, said fluid chamber including a first chamber portion extending between said first and second open ends of said flexible spring member and a second chamber portion between said first open end and said upper end member.

22. An air spring according to claim 21, wherein substantially all of said second chamber portion is disposed within the associated mounting envelope.

23. An air spring according to claim 1, wherein said flexible spring member includes a plurality of bellows.

24. An air spring according to claim 23, wherein said flexible spring member includes a mounting bead disposed along said first open end and said outer peripheral wall portion of said upper end member is crimped around said mounting bead.

25. A suspension assembly according to claim 10, wherein at least one of said first sheet material or said second sheet material has a thickness of from approximately 3/32 of an inch to approximately 3/16 of an inch.

26. A suspension assembly according to claim 10, wherein said flexible suspension member includes a plurality of bellows disposed between opposing open ends, and a mounting bead is formed on said flexible suspension member along each open end.

27. A suspension assembly according to claim 26, wherein said second wall of said second end member includes an outer peripheral wall portion extending radially outwardly from said central wall portion, and said outer peripheral wall portion of said first and second walls are crimped about one of said mounting beads of said flexible suspension member.

28. A suspension assembly adapted for use on an associated vehicle having associated upper and lower vehicle components, the associated upper vehicle component having an associated mounting envelope, said suspension assembly comprising:
an air spring including a first end member, a second end member spaced from said first end member and a flexible spring member secured therebetween and together defining a spring chamber therewith;
a damping member supported between the associated upper and lower vehicle components, said damping member including a housing, a damping rod displaceably received within said housing, a collar supported on said housing, a sealing member disposed between said collar and said housing, and a plurality of displaceable retaining members supported on said collar and extending radially outwardly therefrom, said damping rod including an exposed end and a shoulder formed along said exposed end;
said first end member including a first end wall formed from a first sheet material, said first end wall including a frustoconical wall portion, an outer peripheral portion extending radially outwardly from said frustoconical wall portion and an inner side wall defining an opening extending through said first end wall;
said second end member including a second end wall formed from a second sheet material, said second end wall including a cylindrical wall portion and an outer peripheral wall portion extending outwardly from said cylindrical wall portion, at least one retaining opening extends through said cylindrical wall portion for engaging one of said plurality of displaceable retaining members;
said flexible spring member includes a flexible side wall extending between opposing open ends and includes a plurality of bellows formed therealong, a mounting bead is formed along each of said opposing open ends, and said outer peripheral wall portion of each of said first and second end walls is crimped around a different one of said mounting beads forming a substantially fluid tight seal therebetween;
said air spring is positioned on said damping member such that said cylindrical wall portion of said second end wall is received on said collar of said damping member with said at least one retaining opening engaging one of said plurality of displaceable retaining members, said first end wall is received on said damping member such that said exposed end of said damping rod extends through said opening in said first end wall.

29. A suspension assembly according to claim 28, wherein a portion of said spring chamber is formed along said frustoconical wall portion of said first end wall outwardly of said spring member, and said first end member is positioned along said damping rod such that said portion of said spring chamber extends into the associated mounting envelope.
